(19) United States
(12) Patent Application Publication
(10) Pub. No.: US 2009/0285132 A1
(43) Pub. Date: Nov. 19, 2009

(54) COMPUTER SYSTEM HAVING HANDSFREE FUNCTION OF INTERNET PHONE

(75) Inventors: Tsung-Wen Hsueh, Taipei (TW); Chun-Nan Su, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/250,629

(22) Filed: Oct. 14, 2008

(30) Foreign Application Priority Data
May 16, 2008 (TW) 097117977

(51) Int. Cl. H04M 1/02; H04L 12/16

(52) U.S. Cl. 370/271

(57) ABSTRACT

A computer system having an internet phone with a hands-free function is provided. The computer system includes a computer host and an internet phone. The computer host includes a multimedia player program, an internet communication program, a loudspeaker and a microphone device. The internet phone includes a handset, a telephone microphone and a hands-free switching key. When the hands-free switching program is executed, the audio output task and the audio input task of the multimedia player program are respectively implemented by the loudspeaker and the microphone device of the computer host, and the audio output task and the audio input task of the internet communication program are respectively implemented by the handset and the telephone microphone of the internet phone.

### FIELD OF THE INVENTION

The present invention relates to a computer system, and more particularly to a computer system for executing audio output and input tasks of an internet communication program by using an internet phone.

### BACKGROUND OF THE INVENTION

Conventionally, people are communicated with each other through letters, indoor telephones, public telephones, beepers (also referred as pagers or B.B Call), faxing machines and the like. With increasing development of computer systems and networks, communication technologies have experienced great growth. Nowadays, the communicating ways are not restricted to letters, telephones, short messages or facsimile. For example, electronic mails gradually replace letters; and mobiles and instant messages gradually replace telephones and beepers.

Electronic mails are transferred among different computers through internet connection. In addition, through internet connection, a communication platform such as a blog or a network communication program also provides the communicating functions. In this context, the network communication program is concerned. The network communication program such as MSN Messenger, Yahoo Messenger and Skype program becomes popular instant message tool. Since the user may make telephone calls via the internet by using the Skype program, the Skype program becomes the most popular network communication program in the world. For conforming to the Skype program, many internet phones are developed and commercially available.

When Skype program is executed in the computer system, a microphone device of the computer system may record the voice of the user and then the user's voice will be transmitted to other user's computer system for playback. In other words, the users are allowed to make phone calls over the internet by the Skype program.

FIG. 1 is a schematic audio output/input architecture of a computer system according to the prior art. The computer system 10 of FIG. 1 principally comprises a notebook computer 100, a loudspeaker 200 and a microphone device 300. The loudspeaker 200 and the microphone device 300 are built in the notebook computer 100.

When a multimedia player program M is executed, the notebook computer 100 can implement an audio output task of the multimedia player program M so as to play songs through the loudspeaker 200 for example. In addition, when the multimedia player program M is executed, the notebook computer 100 can implement an audio input task by the microphone device 300 to record audio signals (e.g. songs). The multimedia player program M includes for example a DVD player program, a MP3 player (e.g. Winamp) program or other audio player programs. On the other hand, when an internet communication program I is executed and the user makes phone calls, the notebook computer 100 can implement the audio output task and the audio input task of the internet communication program I by the loudspeaker 200 and the microphone device 300, respectively. In other words, the audio output tasks of the multimedia player program M and the internet communication program I in the computer system 10 are implemented by the loudspeaker 200. Whereas, the audio input tasks of the multimedia player program M and the internet communication program I in the computer system 10 are implemented by the microphone device 300.

FIG. 2 is a schematic audio output/input architecture of a computer system having an internet phone according to the prior art. The computer system 10 of FIG. 2 principally comprises a notebook computer 100, a loudspeaker 200, a microphone device 300 and an internet phone 400. The internet phone 400 comprises a wireless receiver 410, a handset 420 and a telephone microphone 430. In comparison with FIG. 1, the audio output system of FIG. 2 further comprises the internet phone 400.

Please refer to FIG. 2. Via a wireless receiver 410, the internet phone 400 is communicated with the notebook computer 100. Once the internet phone 400 is communicated with the notebook computer 100, the audio output task and the audio input task originally implemented by the notebook computer 100 are switched to be implemented by the internet phone 400. That is, the audio output task and the audio input task of the computer system 10 are switched to be implemented by the handset 420 and the telephone microphone 430, respectively. In other words, once the internet phone 400 is communicated with the notebook computer 100, the audio output task of the multimedia player program M that is originally implemented by the loudspeaker 200 of the notebook computer 100 is switched to be to be implemented by the handset 420 of the internet phone 400; and the audio input task of the internet communication program I that is originally implemented by the microphone device 300 of the notebook computer 100 is switched to be to be implemented by the telephone microphone 430 of the internet phone 400.

The above-mentioned conventional computer system, however, still has some drawbacks. As previously described, when the internet phone 400 is used to make phone calls over the internet, the audio output/input tasks of the internet communication program I and the audio output/input tasks of the multimedia player program M are all implemented by the internet phone 400. That is, the task of playing songs of the multimedia player program M is implemented by the handset of the internet phone 400. At this moment, if the user wants to execute the multimedia player program M, the internet phone 400 needs to be detached from the notebook computer such that the audio output task and the audio input task are respectively implemented by the loudspeaker and the microphone device again. On the other hand, if the user wants to execute the multimedia player program M, the internet phone 400 needs to be communicated with the notebook computer again. This method of operating the computer system is very troublesome to the user.

Furthermore, the internet phone usually has a hands-free function. When the user makes phone calls over the internet by using the internet phone and executing the internet communication program I, the hands-free function allows the audio signals of the internet phone to be outputted through an additional loudspeaker of the internet phone. By pressing down a hands-free function key of the internet phone, the audio output task is implemented by the loudspeaker of the internet phone. For conforming to the additional loudspeaker of the internet phone, the internal circuitry of the internet phone should be modified such that the additional loudspeaker is arranged on a proper location of the internal space. The additional loudspeaker increases hardware cost and complexity of the internet phone.

Therefore, there is a need of providing an improved computer system so as to obviate the drawbacks encountered from the prior art.

### SUMMARY OF THE INVENTION

It is an object of the present invention to provide a computer system having a hands-free function of an internet phone.

Another object of the present invention provides a computer system whose internet phone can be switched between a handheld mode and a hands-free mode

In accordance with an aspect of the present invention, there is provided a computer system having a hands-free function of an internet phone. The computer system includes a computer host and an internet phone. The computer host includes a multimedia player program, an internet communication program, a loudspeaker for implementing audio output tasks of the multimedia player program and the internet communication program, and a microphone device for implementing audio input tasks of the multimedia player program and the internet communication program. The internet phone is electrically connected to the computer for making a phone call. The internet phone includes a handset for implementing audio output tasks of the multimedia player program and the internet communication program, and a telephone microphone for implementing audio input tasks of the multimedia player program and the internet communication program. The computer host further includes a hands-free switching program. When the hands-free switching program is executed, the audio output task and the audio input task of the multimedia player program are respectively implemented by the loudspeaker and the microphone device, and the audio output task and the audio input task of the internet communication program are respectively implemented by the internet phone.

In an embodiment, the hands-free switching program is downloaded into the computer host through an optical disc or a removable storage device or through internet connection.

In an embodiment, the internet phone is communicated with the computer host through a universal serial bus (USB).

In an embodiment, the internet phone further comprises a wireless receiver, which is connected to a universal serial bus (USB) of the computer host.

In an embodiment, the multimedia player program is selected from a DVD player program, a MP3 player (Winamp) program or other audio player program.

In an embodiment, the internet communication program is a Skype program.

In an embodiment, the internet phone further includes a hands-free switching key that is triggered to selectively enable or disenable the hands-free function of the internet phone. The audio output task and the audio input task of the internet communication program are respectively implemented by the handset and the telephone microphone of the internet phone of the internet phone when the hands-free switching key is pressed down to enable the hands-free function.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic audio output/input architecture of a computer system according to the prior art;

FIG. 2 is a schematic audio output/input architecture of a computer system having an internet phone according to the prior art; and

FIG. 3 is a schematic audio output/input architecture of a computer system according to a preferred embodiment of the present invention.

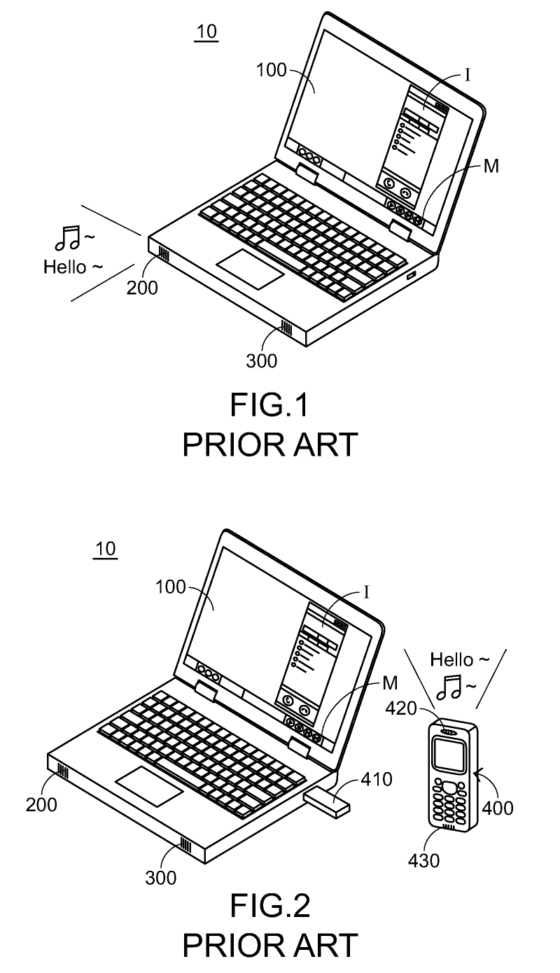

### DETAILED DESCRIPTION OF THE PREFERRED EMBODIMENT

For obviating the drawbacks encountered from the conventional computer system having an internet phone, the prevent invention provides an improved computer system.

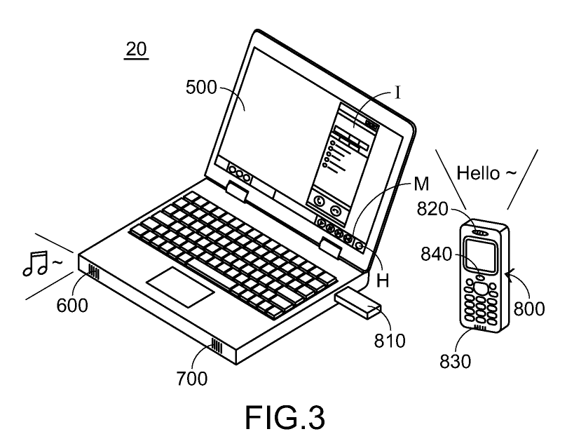

FIG. 3 is a schematic audio output/input architecture of a computer system according to a preferred embodiment of the present invention. The computer system 20 of FIG. 3 principally comprises a notebook computer 500 and an internet phone 800. The notebook computer 500 has a loudspeaker 600, a microphone device 700. The loudspeaker 600 and the microphone device 700 are built in the notebook computer 500. The notebook computer 500 can execute the multimedia player program M and the internet communication program I. An exemplary internet communication program I of this embodiment is the Skype program. The loudspeaker 600 and the microphone device 700 are built in the notebook computer 500. The wireless receiver 810 is plugged into a universal serial bus (USB) of the notebook computer 500. Via a wireless receiver 810, the internet phone 800 is communicated with the notebook computer 500. Alternatively, the internet phone 800 can be directly communicated with the notebook computer 500 through a universal serial bus (USB). The internet phone 800 comprises a handset 820, a telephone microphone 830 and a hands-free switching key 840.

If the internet phone 800 is not communicated with the notebook computer 500, as the conventional technology described above, the loudspeaker 600 of the notebook computer 500 implements audio output tasks of all audio player programs (e.g. the multimedia player program M and the internet communication program I) and the microphone device 700 implements audio input tasks of the audio player programs. On the other hand, if the internet phone 800 is communicated with the notebook computer 500, the audio output task of the multimedia player program M and the audio input task of the internet communication program I are implemented by the internet phone 800.

Hereinafter, operations of the audio output/input architecture of the present invention will be illustrated with reference to FIG. 3. First of all, a hands-free switching program H is downloaded into the notebook computer 500. The process of downloading the hands-free switching program H includes steps of burning the hands-free switching program H into an optical disc or a removable storage device, and then the hands-free switching program H stored in the optical disc or the removable storage device is downloaded into the notebook computer 500. Alternatively, the hands-free switching program H can be stored in a website and downloaded into the notebook computer 500 through internet connection. After the hands-free switching program H is downloaded into the notebook computer 500, the preset components for implementing audio output tasks and audio input tasks of the notebook computer 500 are changed. In particular, the loudspeaker 600 implements the audio output task of the multimedia player program M, the microphone device 700 implements the audio input task of the multimedia player program M, the handset 820 of the internet phone 800 implements the audio output task of the internet communication program I, and the telephone microphone 830 implements the audio input task of the internet communication program I. Under this circumstance, the components for implementing the audio output/input tasks of the multimedia player program M and the components for implementing the audio output/input tasks of the internet communication program I are independent of each other. That is, the audio output tasks of the multimedia player program M and the internet communication program I fail to be simultaneously implemented by the loudspeaker 600 and the handset 820. As a consequence, when the user makes phone calls over the internet by using the internet phone 800 and executing the internet communication program I, the audio output task of the multimedia player program M can also be implemented to play songs by the loudspeaker 600. The audio signals emitted by the internet phone 800 and the loudspeaker 600 are independent of each other and not mixed together.

Moreover, upon execution of the hands-free switching program H, the internet phone 800 will possess a hands-free function. When the user makes phone calls and the hands-free switching key 840 of the internet phone 800 is pressed down, the hands-free function of the internet phone 800 is enabled and the internet phone 800 is operated in a hands-free mode. In the hands-free mode, the audio output task and the audio input tasks of the internet communication program I are respectively implemented by the loudspeaker 600 and the microphone device 700 of the notebook computer 500. Meanwhile, the user can make phone calls over the internet without the need of holding the internet phone 800 by a hand. Provided that the microphone device 700 is effective to receive external audio signals, the user can use the notebook computer 500 or deal with other affairs at the same time when he or she makes phone calls over the internet. On the other hand, when the hands-free switching key 840 of the internet phone 800 is pressed down again, the hands-free function of the internet phone 800 is disenabled and the internet phone 800 is operated in a handheld mode. Meanwhile, the audio output task and the audio input task of the internet communication program I are respectively implemented by the handset 820 and the telephone microphone 830 of the internet phone 800 again.

In the computer system 20 of the present invention, under control of specified program, the audio output task and the audio input task of the internet communication program I are respectively implemented by the loudspeaker 600 and the microphone device 700 in the handheld mode or respectively implemented by the handset 820 and the telephone microphone 830 in the hands-free mode. In comparison with the conventional internet phone with an additional microphone device to implement the hands-free function, the internet phone of the present invention has simplified hardware components and is cost-effective because a hands-free switching program is used to control the hands-free function.

As previously described in the prior art, when the internet phone is communicated with the internet, the audio output tasks of the internet communication program and the multimedia player program are all implemented by the handset of the internet phone; otherwise, when the internet phone is disconnected from the internet, the audio output tasks of the internet communication program and the multimedia player program are all implemented by the loudspeaker of the notebook computer. That is, in the conventional computer system, the internet phone needs to be selectively connected to or disconnected from the notebook computer according to practical requirements. On the other hand, since the components for implementing the audio output/input tasks of the multimedia player program and the internet communication program are independent of each other according to the present invention, the audio output/input tasks of the internet communication program and the multimedia player program can be simultaneously implemented. Furthermore, once the hands-free switching program is downloaded into the notebook computer, the hands-free switching program will be automatically executed at every startup of the notebook computer without the need of manually executing the hands-free switching program. The hands-free switching key can be designed as a click button of the general indoor telephone or mobile phone, and thus easily operated by the user.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A computer system having an internet phone with a hands-free function, said computer system comprising:
a computer host comprising a multimedia player program, an internet communication program, a loudspeaker for implementing audio output tasks of said multimedia player program and said internet communication program, and a microphone device for implementing audio input tasks of said multimedia player program and said internet communication program; and
an internet phone electrically connected to said computer for making a phone call, and comprising a handset for implementing audio output tasks of said multimedia player program and said internet communication program, and a telephone microphone for implementing audio input tasks of said multimedia player program and said internet communication program,
wherein said computer host further comprises a hands-free switching program, and when said hands-free switching program is executed, said audio output task and said audio input task of said multimedia player program are respectively implemented by said loudspeaker and said microphone device, and said audio output task and said audio input task of said internet communication program are respectively implemented by aid internet phone.

2. The computer system according to claim 1 wherein said hands-free switching program is downloaded into said computer host through an optical disc or a removable storage device or through internet connection.

3. The computer system according to claim 1 wherein said internet phone is communicated with said computer host through a universal serial bus (USB).

4. The computer system according to claim 1 wherein said internet phone further comprises a wireless receiver, which is connected to a universal serial bus (USB) of said computer host.

5. The computer system according to claim 1 wherein said multimedia player program is selected from a DVD player program, a MP3 player (Winamp) program or other audio player program.

6. The computer system according to claim 1 wherein said internet communication program is a Skype program.

7. The computer system according to claim 1 wherein said internet phone further comprises a hands-free switching key that is triggered to selectively enable or disenable said hands-free function of said internet phone, wherein said audio output task and said audio input task of said internet communication program are respectively implemented by said handset and said telephone microphone of said internet phone when said hands-free switching key is pressed down to enable said hands-free function.
